(19) United States
(12) Patent Application Publication
(10) Pub. No.: US 2024/0102584 A1
(43) Pub. Date: Mar. 28, 2024

(54) FIRESTOP DEVICE FOR PENETRATIONS THROUGH FIRE-RESISTANT MATERIAL

(71) Applicant: Sharron Halpert, Ridgewood, NJ (US)

(72) Inventor: Sharron Halpert, Ridgewood, NJ (US)

(21) Appl. No.: 18/369,625

(22) Filed: Sep. 18, 2023

Related U.S. Application Data
(60) Provisional application No. 63/409,647, filed on Sep. 23, 2022.

(51) Int. Cl. F16L 5/04; A62C 3/16

(52) U.S. Cl. CPC F16L 5/04; A62C 3/16

(57) ABSTRACT

In an embodiment of the disclosed principles, a firestop device is provided for a variety of fire rated or fire blocking construction suitable for PENETRATIONS of plastic or metal pipes, cables, conduits or other construction materials is disclosed. The firestop device is sized for the penetrating item and is as easy to install as the brackets and grommets that the various trades are familiar with, but it will provide firestop capacity as well. This means life safety will be improved my providing an easier solution with a prescribed dose of intumescent (expanding firestop) material.

### RELATED APPLICATION

This application claim is related to and claims priority from U.S. Provisional Application Ser. No. 63/409,647 entitled “A Firestop Device Designed to Protect Various Different Penetrations Through Any Fire-Resistance Rated Construction or Fireblock Applications,” filed on Sep. 23, 2022, which application is incorporated herein by reference in its entirety for all that it teaches, discloses or suggests, without exclusion of any portion thereof.

### TECHNICAL FIELD

The present disclosure is related generally to firestop technology and, more particularly, in an embodiment of the described principles, to a firestop device designed to protect various penetrations through fire-resistance rated construction or fireblock applications.

### BACKGROUND

In the construction arts, cables and pipes and other construction penetrations are often required to be secured in order to prevent movement or abrasion. This may be accomplished via a bracket that secures a penetration or a grommet that protects against abrasion. When a PENETRATION (penetrations defined as MEPS service line—MEPS—Mechanical, Electrical, Plumbing, Fire Sprinkler or ancillary service item such as threaded rod, seismic bracing, pipe racks or other supports) penetrates through or into an FRA (Fire-resistance Rated Assembly that can include but is not limited to a floor, roof or wall assembly tested in accordance with ASTM E119 or UL 263, but can also include any fire block material as is acceptable pursuant to the local building code), the PENETRATION is required to provide a fire resistance rating equivalent to the FRA. This is often accomplished with firestop sealants tested to the appropriate standards. In the US that is ASTM E814 or UL 1479. However, such installations are often substandard or non-compliant due to difficulties such as those discussed later herein.

Before proceeding, it should be appreciated that while the present disclosure is directed to a system that may address some of the shortcomings listed or implicit in this Background section, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventor expressly disclaims this section as admitted or assumed prior art. Moreover, the identification herein of one or more desirable courses of action reflects the inventors' own observations and ideas, and should not be assumed to indicate an art-recognized desirability.

### SUMMARY

When a PENETRATION runs through any FRA, the resulting space needs to be capable of preventing the spread of fire through the FRA. In an embodiment of the disclosed principles, a device is provided having the support of a bracket, the protection of a grommet and the firestop of a sealant with one simple installation that is easier to install right than to install wrong. The disclosed system can be made in any size needed to accommodate an array of different PENETRATIONS and can work in any firestop or fireblock application.

To install the device, a hole is created in the FRA to run the PENETRATION. The item is run—either a membrane penetration or a through penetration. The disclosed device is then installed around the PENETRATION and into the annular space, or prior to inserting the PENETRATION. The device may then be fastened to the FRA and may be inspected to ensure conformance to the listed detail. This device could also be used as a fire block as well as a firestop product. This device could be installed without a penetrating item to allow for future PENETRATIONS to be run if necessary. While this device is designed for use in construction, renovation or maintenance of fire resistance rated assemblies, it could potentially be used in marine firestop, aviation or any other area where limiting the spread of fire is imperative.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a perspective representation of firestop device in accordance with an embodiment of the disclosed principles showing example measurements;

FIG. 2 is a perspective representation of the firestop device of FIG. 1 in accordance with an embodiment of the disclosed principles; and

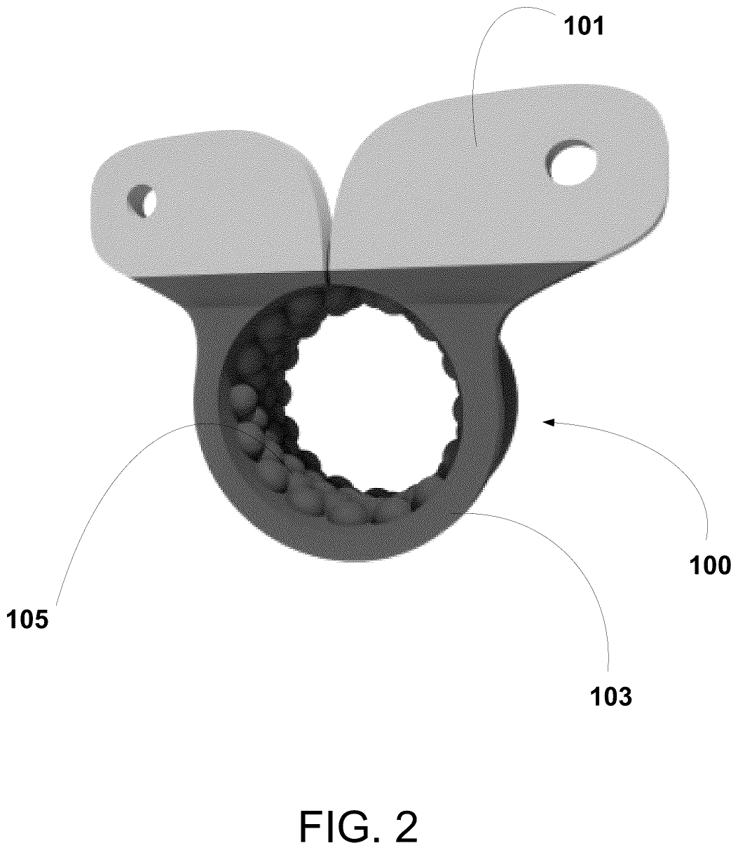

FIG. 3 is another perspective representation the firestop device of FIG. 1 in accordance with an embodiment of the disclosed principles.

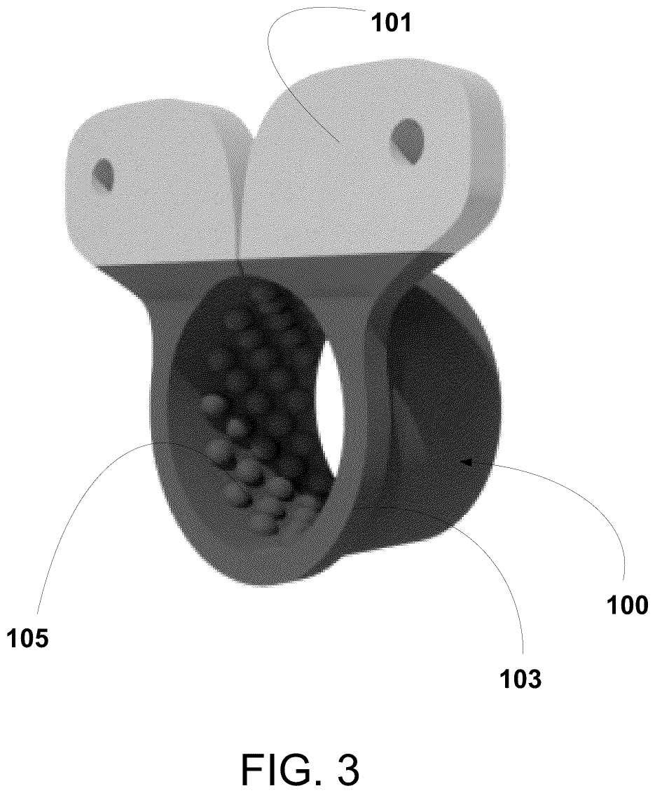

### DETAILED DESCRIPTION

As noted above, PENETRATIONS are often required to be secured to prevent movement or abrasion, generally using a bracket to prevent movement or a grommet that protects against abrasion. When a pipe, cable or conduit (MEPS service line—MEPS—Mechanical, Electrical, Plumbing, Fire Sprinkler) penetrates through or into an FRA, the MEPS service lines and other types of Penetrations are required to provide a fire resistance rating equivalent to the FRA. This is often done with firestop sealants tested to the appropriate standards. In the US that is ASTM E814 or UL 1479.

However, brackets interfere with the installation of the firestop sealant, creating a fire risk, and grommets are often not listed in the ASTM/UL test documents, which is a code violation. Moreover, through-holes are often not sized large enough to accommodate both the penetration and the firestop sealant, so applications are frequently noncompliant. In short, it is difficult to install the traditional sealant installation correctly, which often results in mistaken confidence in the installations and poses a liability in the event of a fire.

For example, firestop sealant in wood framed construction is typically required to be installed ¾″ deep, and if the remaining space for the required sealant depth only allows a gap of ⅛″ it becomes difficult to install the required ¾″ sealant depth given the space restrictions. In normal construction conditions, time is at a premium and these types of hurdles can result in substandard fire protection. Due to changes in the building code, more projects are requiring special inspection of firestop and these deficiencies with traditional firestop solutions can often have a negative impact on both schedules and budgets when they are identified by inspectors. If they are not identified by inspectors, they pose a liability to the people who live, work and play in the building when it is occupied.

The disclosed invention provides the support of a bracket, the protection of a grommet and the firestop of a sealant with one simple installation that is easier to install right than to install wrong. The disclosed system can be made in any size needed to accommodate an array of different PENETRATIONS and can work in any firestop or fireblock application.

When a pipe, conduit, cable or other construction material or service item passes through an FRA, the resulting space needs to be capable of preventing the spread of fire through the rated assembly. A hole is created to run the service item and a PENETRATION is run—either as a membrane penetration or as a through penetration. The disclosed device is then installed around the penetrating item and into the annular space. The device is then fastened to the FRA and may be inspected to ensure conformance to the listed detail. This device could also be used as a fire block as well as a firestop product. This device could be installed without a penetrating item to allow for future PENETRATIONS to be run if necessary. While this device is designed for use in construction, renovation or maintenance of fire resistance rated assemblies, it could potentially be used in marine firestop, aviation or any other area where limiting the spread of fire is imperative.

With this overview in mind, we turn now to a more detailed discussion of the disclosed principles in conjunction with the attached figures. The disclosed firestop device contains a determined amount of intumescent material housed in a bracket that will serve the role of traditional bracket, grommet and firestop in one device. This intumescent material may be an extruded or a co-extruded material that uses both an intumescent extrusion as well as potentially another non-intumescent plastic extrusion.

This hybrid option may be the best option for strength, bulk, cost or any array of other reasons. This or other embodiments may alternatively or additionally include an intumescent strip for certain applications where needed, such as Polyurethane insulation, larger combustible PENETRATIONS such as (but not exclusively) plastic pipes, conduits, tubes, large cables or cable bundles insulated pipes etc.

As noted above, existing brackets can actually prevent proper firestop installation by filling the annular space that should be occupied by the firestop and as such, firestop sealants are often installed to insufficient depth. The disclosed solution solves this problem via a single solution that is more easily installed correctly. Additionally, projects that are designed to be deconstructed after use will be able to be disassembled and later reuse the same device in a way that traditional firestop solutions would not be able to be used.

The firestop device should be sized for the penetrating item and will be as easy to install as the existing brackets which the trades are familiar with installing. They will be easier to install correctly, which means life safety will be improved by providing an easier solution with a prescribed dose of intumescent (expanding firestop) material.

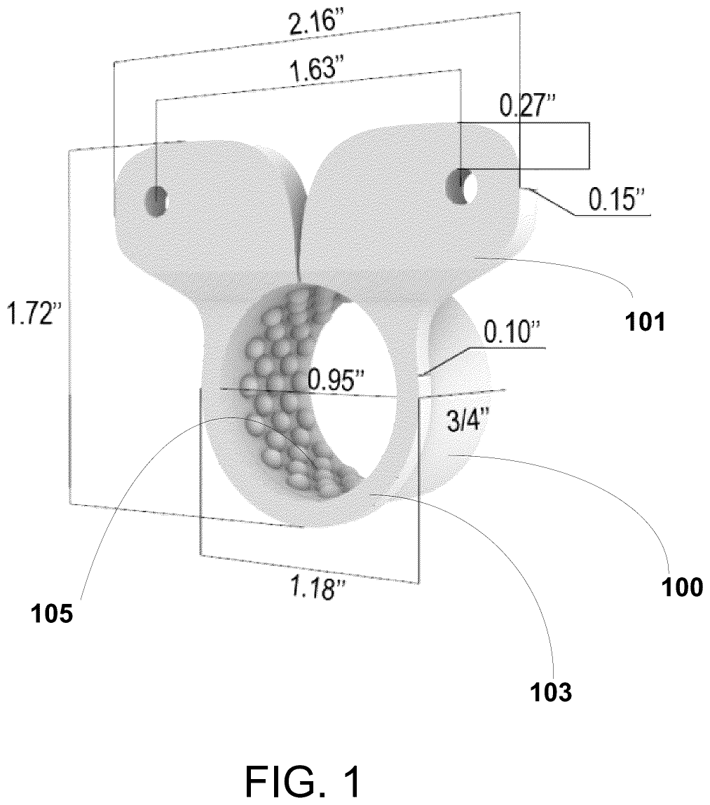

The illustrated example (see, e.g., FIG. 1) includes a base 100, as well as tabs 101. An internal texture 103 and skirt 105 are also provided. The base 100 provides fire protection, because it is made of an intumescent material, in an embodiment, that will expand in a fire. It may be installed into the FRA and in conjunction with the texture 103, will secure the penetrant in place. The base 100 may also be flexible to allow installers to open the bracket to work it around the penetrating item.

The base 100 may be of varying wall thickness, length, diameter etc. to accommodate different construction materials which may have differing PENETRATION sizes, different combustibility (metal, plastic etc.) or different FRA requirements (mass timber, gypsum walls, wood framed assembly, hollow core, Hambro, concrete and others). The intumescent firestop material of the base 100 may be co-extruded with another plastic for the tabs 101 to reduce cost and improve performance, it may be created with the same material or it may have a separate intumescent strip added in the manufacturing process depending on how much intumescent power is required for a particular penetrant. The base 100 may have a slit between the tabs 101 that will allow it to open and wrap around a penetrating item such as pipe, cable conduit etc. The base around the slit may be of different thickness to allow the firestorm device to be closed down around a cable or other smaller application that may require a tighter bracket capture.

The base 100 may function with the texture 103 to reduce movement of the penetrating item, but in the event of building movement, the tabs 101 will prevent the firestop device from becoming dislodged from the FRA. This is a common issue with traditional firestop sealant products. The tabs 101 may be fastened and tightened as needed to secure a PENETRATION. In an embodiment for non-combustible PENETRATIONS, the base 100 may be co-extruded with the texture 103 being the only intumescent element. The base 100 may be available in multiple sizes to accommodate various sized PENETRATIONS and coverings.

The tabs 101 are used as noted above to secure the device in the rated assembly and can be tightened to clamp the PENETRATION tighter if necessary. In the event that a penetrating item needs to allow for movement, the tabs 101 can be opened, and the device can remain positioned in the FRA where traditional sealants are often found to become dislodged from the FRA and are no longer capable of performing as expected when they are no longer located in the plane of the FRA after movement of the penetrating item in relation to the FRA.

One example of this is with wood framed construction. It can shrink as much as ¼′″ per floor. This means a 5-storey building may shrink 1¼″. If sealant is required to be installed ¾″ deep and there is 1¼″ of movement, then even with the proper amount of sealant installed, the installation may nonetheless drift out of safe compliance. The tabs 101, when properly fastened, will prevent that occurrence.

The tabs 101 may be slender where they meet to accommodate overlapping when device needs to be fastened more tightly around smaller PENETRATIONS. The tabs 101 are show in North orientation but could be reconfigured to be in the East/West orientation.

The texture 103, though not required, may be inside the base 100, outside the base 100 or both. Interior texture 103 will aide in preventing movement of penetrating item and when expansion/contraction space is needed the texture could aide in the cooling of PENETRATIONS. Exterior texture (not shown) will help prevent the device from being dislodged from the rated assembly which would render the device useless in a fire scenario.

The interior texture 103 may run longitudinal, latitudinal or in a spiral, and may be nipples or other suitable shape. Exterior texture could run in any configuration but likely will be spiral to allow the device to be screwed into wood or drywall or to be pressed into concrete or block applications. The texture 103 may be extruded intumescent or co-extruded over non-intumescent if different grip is beneficial to various MEPS trades.

The skirt 105, when used, will allow for an installation in a larger annular space to still pass the early phases of the fire test without allowing flame promulgation. A T model of the device will provide a T rating and will be made of an endothermic material similar to the texture. This could be done with the texture or with the skirt. T ratings are required by code when penetrations through floors are not located in a wall cavity or membrane penetrations through a wall. This is a commonly overlooked code requirement that has been on the books since at least the late 1990s.

The skirt 105 will also help provide an L rating (air leakage that has implications in smoke control and smoke barrier assemblies) which is required on smoke barriers pursuant to the International Building Code.

In operation, the bracket design helps secure the penetrating item in place, reducing movement and preventing shifting of firestop material out of the plane of the fire resistance rated assembly where it is required to be located if it is expected to perform appropriately. It can be fastened to the rated assembly to ensure it will not move. It can be closed down around a PENETRATION to provide more hold to the penetrating item if necessary. The intumescent base 100 will expand in a fire scenario closing down the opening and prevent fire promulgation. The base 100 will be relatively flexible so that it can open around a pipe or cable. It will be of the thickness required to impart sufficient intumescent material as required to close down the various PENETRATIONS, this will be determined by the results of the fire tests as we work with varying sizes of PENETRATIONS with varying levels of combustibility and various device configurations.

The base 101 will be sized to an appropriate diameter for various sized pipes, conduits and cables. It may be configured to provide F, T, M, W and L ratings. Everything attaches to the base of this firestop device which may be made of intumescent or plastic material. The texture could be in any form format or material—examples longitudinal, latitudinal or spiral ridges or nipples that will grab the PENETRATION and prevent movement. The texture could be intumescent material or of a different plastic, rubber or other material that can be extruded or potentially co-extruded.

The skirt 105 may be a thin intumescent material that will allow for openings with excess annular space. It will support passing the F rating if there is excess annular space and can be used in conjunction with a sealant or adhesive to provide an L rating when required by code.

In an embodiment, the base 101 and skirt 105 are made of an extruded intumescent material such as a graphite-based material, but is not limited to that, as some versions will require an endothermic capacity and may need different materials. The tabs 101 and texture 103 may be made of the same material or in some versions may be co-extruded. The tabs 101 may be Polyurethane, Polypropylene, or other plastic extrusion material.

Sizes will vary and as the brackets get larger the walls of the device may get thicker, so that more intumescent materials are in place to close down a larger plastic pipe. It may be cost effective to make a device with a longer base in certain rated assemblies and a shorter one in others. This could be due to fire performance or assembly depth. The skirt 105 can be thinner than the base 101 because the orientation to the base 101 will require it to be more flexible as it is opened to accommodate the penetrating item.

The form of the texture 103 may vary depending on the need of the various trades. In some cases a T rating may be required so the texture or the skirt may be modified to be made of material that can support these code requirements. The skirt 105 is an option that may only be necessary when an L rating is required or if it can be made of a material that helps maintain a T rating, particularly for membrane PENETRATIONS in walls or floor PENETRATIONS outside of a wall cavity.

The base 101 may need to be longer in some FRAs (such as mass timber) or shorter in others (such as gypsum walls). The diameter of the base 101 will remain flexible and may vary to accommodate different sized penetrating items. In any event, the material used to create the tabs 101 should be strong enough to receive a fastener but malleable enough to not prevent the device from opening to fit around a PENETRATION. The thickness may vary as well as the material it is made of. The size of the skirt 105 may vary depending on the level of flexibility restrictions it creates, the size of the excess annular space seen in the field, the requirements of L and T rating provisions and more.

In an alternative embodiment, the device is made with an intumescent belt/wrap strip inserted into the formed plastic (which may or may not be intumescent) following the injection molding process. The thickness of the device can vary based on required texture, inside and outside of bracket, wings shape size and orientation. In a further embodiment, the tabs 101 are formed on the sides similar to wings, on an east and west face, rather than the ear configuration illustrated. Moreover, other numbers of tabs 101 may be used, e.g., 1, 3, 4 and so on.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “such that,” and “operable to” do not imply any particular tangible or intangible modification of a subject, but, rather, are intended to be used interchangeably. A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology.

A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The words “exemplary,” “exemplify,” and “example” are used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

We claim:

1. A firestop device for installation at a PENETRATION in a fire-resistant surface for a penetrating element, the firestop device comprising:
a cylindrical base for passage of the PENETRATION element, having a wall and a slit opening in the wall;
an intumescent material within the cylindrical base;
a skirt affixed to one end of the cylindrical base, having therein a slit opening coincident with the slit opening in the wall of the cylindrical base; and
one or more tabs affixed to at least one of the skirt and the cylindrical base, such that the firestop device can be affixed to the fire-resistant surface via the one or more tabs with the cylindrical base passing through an opening in the fire-resistant surface and allowing passage of the penetrating element through the fire-resistant surface via the cylindrical base.

2. The firestop device in accordance with claim 1, wherein the intumescent material is extruded or coextruded with the cylindrical base.

3. The firestop device in accordance with claim 1, wherein the cylindrical base is comprised of the intumescent material.

4. The firestop device in accordance with claim 3, wherein the one or more tabs are non-intumescent, and wherein the cylindrical base is coextruded with the one or more tabs.

5. The firestop device in accordance with claim 1, wherein the intumescent material is comprised of a strip or belt of material applied to an inner surface of the cylindrical base.

6. The firestop device in accordance with claim 5, wherein the strip or belt of intumescent material comprises a surface pattern comprising an array of protrusions.

7. The firestop device in accordance with claim 1, wherein the intumescent material is extruded in a pattern comprising an array of protrusions.

8. A method of installing a firestop device at a PENETRATION in a fire-resistant surface for a penetrating element, the method comprising:
placing into the PENETRATION a firestop, the firestop having:
a cylindrical base for passage of the penetrating element, having a wall and a slit opening in the wall;
an intumescent material within the cylindrical base;
a skirt affixed to one end of the cylindrical base, having therein a slit opening coincident with the slit opening in the wall of the cylindrical base; and
one or more tabs affixed to at least one of the skirt and the cylindrical base, such that the firestop device can be affixed to the fire-resistant surface via the one or more tabs with the cylindrical base passing through an opening in the fire-resistant surface and allowing passage of the penetrating element through the fire-resistant surface via the cylindrical base; and
affixing the placed firestop in the PENETRATION.

9. The method in accordance with claim 8, wherein the intumescent material is extruded or coextruded with the cylindrical base.

10. The method in accordance with claim 8, wherein the cylindrical base is comprised of the intumescent material.

11. The method in accordance with claim 10, wherein the one or more tabs are non-intumescent, and wherein the cylindrical base is coextruded with the one or more tabs.

12. The method in accordance with claim 8, wherein the intumescent material is comprised of a strip or belt of material applied to an inner surface of the cylindrical base.

13. The method in accordance with claim 12, wherein the strip or belt of intumescent material comprises a surface pattern comprising an array of protrusions.

14. The method in accordance with claim 8, wherein the intumescent material is extruded in a pattern comprising an array of protrusions.
